(19) United States
(12) Patent Application Publication
(10) Pub. No.: US 2016/0103642 A1
(43) Pub. Date: Apr. 14, 2016

(54) PRINTING DEVICE AND CONTROL METHOD OF A PRINTING DEVICE

(71) Applicant: Seiko Epson Corporation, Tokyo (JP)

(72) Inventor: Tomoyuki OI, Matsumoto-shi (JP)

(73) Assignee: Seiko Epson Corporation, Tokyo (JP)

(21) Appl. No.: 14/851,950

(22) Filed: Sep. 11, 2015

(30) Foreign Application Priority Data
Sep. 12, 2014 (JP) 2014-186045
Sep. 12, 2014 (JP) 2014-186046
Sep. 12, 2014 (JP) 2014-186083

(51) Int. Cl. G06F 3/12; B41J 2/105; B41J 2/075

(52) U.S. Cl. CPC G06F 3/1243; G06F 3/1294; G06F 3/1208; B41J 2/075; B41J 2/105

(57) ABSTRACT

A printing device and a control method of a printing device efficiently execute a process of merging plural data objects and printing. The printer has a printer control unit that interprets and renders plural print object datas on plural layers, and generates print data by overwriting and merging one layer on another layer, and a print unit that prints based on the print data generated by the printer control unit.

Priority is claimed under 35 U.S.C. 119 to Japanese Patent Application No. 2014-186083 filed on Sep. 12, 2014, Japanese Patent Application No. 2014-186045 filed on Sep. 12, 2014 and Japanese Patent Application No. 2014-186046 filed on Sep. 12, 2014, all of which are incorporated by reference in their entireties.

### BACKGROUND

1. Technical Field

The present invention relates to a printing device and a control method of a printing device.

2. Related Art

Methods that merge image data for plural images to create a single composite image by rendering image data in layers and stacking the rendered images together to create the composite image are known from the literature. JP-A-2009-5131, for example, describes a device that renders an image by overwriting another image to an image layer already rendered in memory to reduce the required memory capacity.

In general, printing devices that print based on text, image, or other data print based on data supplied from a host device. When such printing devices merge print data, however, a method of assuring print quality and efficient processing is needed.

### SUMMARY

The present invention provides a printing device and a control method of a printing device that can maintain quality while efficiently executing a process that prints by merging plural data streams.

A printing device according to at least one embodiment of the invention includes an image processing unit that interprets and renders plural print object data on plural layers, and produces print data by merging layers by overlaying one layer on another layer; and a print unit that prints based on the print data generated by the image processing unit.

The printing device according this aspect of the invention renders print object data as images on layers, and uses the layers to merge and print a composite image. A drop in print quality can therefore be prevented and the required memory capacity can be suppressed in a process that generates print data by merging print object data. The printing device can therefore efficiently merge and print print object data.

Preferably, the printing device also has memory that stores plural layers, the memory having a plurality of storage areas corresponding to the plural layers, and the plural storage areas having different storage capacities.

Thus comprised, data can be efficiently merged and printed using storage areas suited to the amount of data rendered on the layers.

Further preferably, the layers include a two-valued layer and a multi-valued layer; and the image processing unit renders a two-valued image on the two-valued layer and a multi-valued image on the multi-valued layer.

This aspect of the invention stores two-valued (monochrome) layer images in a storage area with a small storage capacity, stores multi-valued images in a storage area with a large storage capacity, and uses memory efficiently to merge data.

Further preferably, the image processing unit interprets and renders the print object data appropriately on the two-valued layer and multi-valued layer.

This aspect of the invention renders print object data on the appropriate layer, and uses memory efficiently to merge data.

In a printing device according to another aspect of at least one embodiment of the invention, the image processing unit renders the print object data on the two-valued layer when the print object data is two-valued image data, and renders the print object data on the multi-valued layer when the print object data is multi-valued image data.

This aspect of the invention renders print object data on the appropriate layer, and uses memory efficiently to merge data.

In a printing device according to another aspect of at least one embodiment of the invention, the print unit prints continuously to plural print areas; and the image processing unit renders the print object data acquired for each print area on the two-valued image, and renders print object data common to plural print areas on the multi-valued layer.

This aspect of the invention can efficiently execute a process of continuously printing to plural print areas.

A printing device according to another aspect of the invention preferably also has a reception unit that receives the print object data.

This aspect of the invention can efficiently execute a process of receiving, merging, and printing print object data.

A printing device according to another aspect of at least one embodiment of the invention preferably also has a print object data storage unit that stores the print object data; the image processing unit rendering the print object data received by the reception unit on the two-valued layer, and rendering the print object data stored in the print object data storage unit on the multi-valued layer.

Thus comprised, data received by the reception unit and data stored in a storage unit can be efficiently merged and printed.

In a printing device according to another aspect of at least one embodiment of the invention, the image processing unit executes a process setting one of the plural layers as the active layer. and a process rendering the print object data on the active layer.

Thus comprised, print object data is rendered on the active layer selected from among plural layers, and printed. As a result, a drop in print quality can be prevented and the required memory capacity can be suppressed in a process that generates print data by merging print object data. The printing device can therefore efficiently merge and print print object data. The layer for rendering the print object data can also be quickly decided, and process efficiency can be improved.

A printing device according to another aspect of at least one embodiment of the invention preferably also has a configuration data storage unit that stores data related to the active layer setting.

Thus comprised, the active layer setting can be saved, the frequency of setting the active layer can be reduced, and the task of setting the active layer can be made more efficient.

In a printing device according to another aspect of at least one embodiment of the invention, when the two-valued layer is the active layer, the image processing unit renders a two-valued image on the two-valued layer based on the print object data of a color image; and the print unit prints the two-valued image rendered on the two-valued layer.

Thus comprised, by setting the two-valued layer as the active layer, monochrome printing based on color print object data is possible.

In a printing device according to another aspect of at least one embodiment of the invention, the image processing unit overwrites the active layer to another layer and produces print data; and the print data prints based on the print data generated by the image processing unit.

Thus comprised, the active layer can be merged and printed with another layer. Because the active layer is merged with another layer in the process that merges images, a storage area for the merging process separate from these layers is not required, and data can be merged while using memory efficiently.

In a printing device according to another aspect of at least one embodiment of the invention, the print unit prints continuously to plural print areas; and the image processing unit renders the print object data acquired for each print area on the active layer.

This aspect of the invention enables efficiently executing a process that prints continuously to plural print areas.

A printing device according to another aspect of at least one embodiment of the invention further comprises a reception unit that receives the print object data; and the image processing unit renders the print object data received by the reception unit on the active layer.

This aspect of the invention can efficiently execute a process of receiving, merging, and printing print object data.

A printing device according to another aspect of at least one embodiment of the invention preferably also has a reception unit that receives a command; and the image processing unit executes a process of interpreting the command received by the reception unit and selecting a layer based on the command, and a process of rendering the print object data on the selected layer.

This aspect of the invention renders and prints print object data on a layer selected based on a command. The layer for rendering the print object data can also be quickly decided, and process efficiency can be improved. A drop in print quality can also be prevented and the required memory capacity can be suppressed in a process that generates print data by merging print object data. The printing device can therefore efficiently merge and print print object data.

In a printing device according to another aspect of at least one embodiment of the invention, the print unit receives the print object data; and the image processing unit renders the two-valued print object data received by the reception unit on the two-valued layer.

This aspect of the invention receives print object data by the reception unit that receives commands, renders the print object data on the appropriate layer, and uses memory efficiently to merge data.

In a printing device according to another aspect of at least one embodiment of the invention, the reception unit receives the command related to selection of the layer each time the print object data is received.

Thus comprised, the layer for rendering print object data that is received with a command related to the layer selected can be selected according to the received command.

A printing device according to another aspect of at least one embodiment of the invention preferably also includes a configuration data storage unit that stores data related to the layer the image processing unit selects based on the command.

Thus comprised, the active layer setting can be saved, the frequency of setting the active layer can be reduced, and the task of setting the active layer can be made more efficient.

In a printing device according to another aspect of at least one embodiment of the invention, the print unit prints continuously to plural print areas; and the image processing unit renders the two-valued print object data the reception unit receives for each print area, and multi-valued print object data common to plural print areas.

Thus comprised, when continuously printing plural print areas, print object data that differs in each of the print areas, and print object data that is the same in plural print areas can be efficiently rendered. Because the print object data that is different in each print area is binary (two-valued) data, the processor load can also be reduced.

In a printing device according to another aspect of at least one embodiment of the invention, the print unit has a line head that ejects ink.

Thus comprised, a printing device with an inkjet line head can efficiently merge and print data to be printed.

Another aspect of at least one embodiment of the invention is a control method of a printing device, including steps of: interpreting and rendering plural print object data on plural layers; producing print data by merging layers by overlaying one layer on another layer; and printing based on the generated print data.

Thus comprised, print object data can be rendered as images in layers, and the layers can be used to merge images and print a composite image. A drop in print quality can therefore be prevented and the required memory capacity can be suppressed in a process that generates print data by merging print object data. The printing device can therefore efficiently merge and print print object data.

A control method of a printing device according to another aspect of at least one embodiment of the invention preferably also comprises: setting one of the plural layers as the active layer; rendering the print object data on the active layer; and printing based on the result of rendering data.

Thus comprised, print object data is rendered on the active layer selected from among plural layers, and printed. As a result, a drop in print quality can be prevented and the required memory capacity can be suppressed in a process that generates print data by merging print object data. The printing device can therefore efficiently merge and print print object data. The layer for rendering the print object data can also be quickly decided, and process efficiency can be improved.

Further preferably, the control method of a printing device further includes interpreting a command and selecting a layer based on the command; and rendering the print object data on the selected layer.

This aspect of the invention renders and prints print object data on a layer selected based on a command. The layer for rendering the print object data can also be quickly decided, and process efficiency can be improved. A drop in print quality can also be prevented and the required memory capacity can be suppressed in a process that generates print data by merging print object data. The printing device can therefore efficiently merge and print print object data.

Further preferably, in the step of rendering the print object data in the control method of a printing device according to another aspect of at least one embodiment of the invention, when the layers include a two-valued layer and a multi-valued layer, the step of rendering the print object data includes interpreting and allocating the print object data to the two-valued layer and the multi-valued layer, rendering two-valued images on the two-valued layer, and rendering multi-valued images on the multi-valued layer.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a function block diagram of a printing system according to a first embodiment of the invention.

FIGS. 2A and 2B are plan views illustrating an example of printing on label paper.

FIGS. 3A, 3B and 3C describe processing layers.

FIG. 4 is a flow chart of the operation of the printing system.

FIG. 5 is a flow chart of the operation of a printing system according to a second embodiment of the invention.

FIG. 6 is a flow chart of the operation of the host computer in the second embodiment of the invention.

FIG. 7 is a flow chart of the operation of the printer in the second embodiment of the invention.

FIG. 8 is a flow chart of the operation of the host computer in a third embodiment of the invention.

FIG. 9 is a flow chart of the operation of the printer in the third embodiment of the invention.

### DESCRIPTION OF EMBODIMENTS

### Embodiment 1

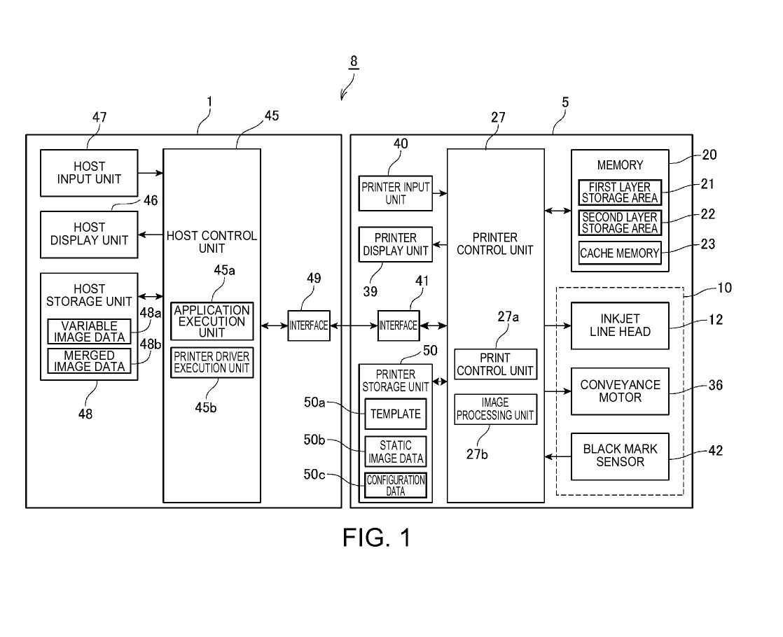

FIG. 1 is a function block diagram of a printing system 8 according to a first embodiment of the invention.

The printing system 8 includes a printer 5 (printing device) connected to a host computer 1 (host device) that controls the printer 5.

The printing system 8 is a system in which a host computer 1 sends (outputs) data based on user operations, and the printer 5 receives the data sent from the host computer 1 and prints based on the received data.

The host computer 1 has a host control unit 45 that controls other parts of the host computer 1. The host control unit 45 includes an application execution unit 45a and a printer driver execution unit 45b.

The application execution unit 45a executes application programs such as a word processing program, image editing program, or POS application program. When the execution of a printing process is commanded by a user operation, the application execution unit 45a generates and outputs information for printing the document or image created by the application program. This information includes either or both image data and text data.

The printer driver execution unit 45b executes a device driver program that controls the printer 5. The printer driver execution unit 45b generates commands to control the printer 5, and sends the commands and data related to the commands to the printer 5. For example, the printer driver execution unit 45b may send data output by the application execution unit 45a, and a print command instructing the printer 5 to print. In addition, when the printer 5 prints an image based on data stored in the printer 5, the printer driver execution unit 45b generates a command identifying the data to print.

The printer driver execution unit 45b can also generate and send control commands for controlling non-printing processes to the printer 5. The printer driver execution unit 45b can also send a control command to the printer 5, and receive and analyze the response returned by the printer 5 in response to the control command it received.

The device driver program run by the printer driver execution unit 45b may be a program optimized for the specific printer 5, or a generic device driver program. The device driver program run by the printer driver execution unit 45b may also be a device driver program for a different model of printer than the specific printer 5, in which case the printer 5 must simply be able to process commands and data intended for that other model of printer.

Connected to the host control unit 45 are a host display unit 46, host input unit 47, host storage unit 48, and interface 49.

The host display unit 46 connects to an LCD display or other type of display device (not shown in FIG. 1). The host display unit 46 displays the results of processes executed by the host control unit 45, and the content of operations detected by the host input unit 47 on the display device as controlled by the host control unit 45.

The host input unit 47 connects to input devices (not shown in FIG. 1) such as a keyboard and mouse or other pointing device. When the operator uses an input device, the host input unit 47 detects the operation and outputs operation data representing the content of the operation to the host control unit 45.

The host storage unit 48 nonvolatilely stores programs and data. The host storage unit 48 can be a storage area in a semiconductor storage device, a magnetic storage medium, or an optical storage medium, for example. The host storage unit 48 stores a control program and application programs run by the host control unit 45, and data related to the programs.

The host storage unit 48 stores variable image data 48a (print object data) and merged image data 48b. The variable image data 48a represents data of an image that the printer 5 prints (containing, for example, an image, text, or barcode data). The printer driver execution unit 45b generates and stores the variable image data 48a based on information output by the application execution unit 45a in the host storage unit 48, and sends the variable image data 48a to the printer 5.

The variable image data 48a is data generated by the application execution unit 45a, or data the application execution unit 45a acquires from an external device (not shown in the figure).

The merged image data 48b is data that the printer 5 merges and sends to the host computer 1.

The interface 49 connects to the printer 5. The interface 49 communicates with the printer 5 as controlled by the host control unit 45. The interface 49 may be a wired communication interface for communicating through a cable, or a wireless communication interface for communicating wirelessly through a wireless LAN or using Bluetooth™, for example. The interface 49 also includes any required hardware such as a connector for physical connection, antenna, and interface circuits.

The printer 5 is a device that prints on print media, and in this embodiment of the invention, is an inkjet printer. The printer 5 has a print unit 10 as the component for printing on print media. The printer 5 also has a printer control unit 27 that controls other parts of the printer 5, and the print unit 10 prints as controlled by the printer control unit 27.

The print unit 10 includes an inkjet line head 12, a conveyance motor 36, and a black mark sensor 42.

The inkjet line head 12 has a row of nozzles in a direction perpendicular to the conveyance direction of the print medium, and ejects ink onto the printing surface of the print medium. The nozzles of the inkjet line head 12 are disposed over the entire printing area, and the entire printing area can be printed without moving the inkjet line head 12. The inkjet line head 12 has a separate nozzle row for each of the four colors cyan (C), magenta (M), yellow (Y), and black (K) to enable full-color printing. The inkjet line head 12 is not so limited, however, and may have nozzle rows for five or more colors of ink, or only one or two nozzle rows for one or two colors of ink.

The print medium used in the printer 5 may be cut-sheet media precut to a specific size, or continuous sheet media. The sheet media may be paper or plastic, and may have a surface coating. Examples of continuous sheet media include roll paper and fanfold paper.

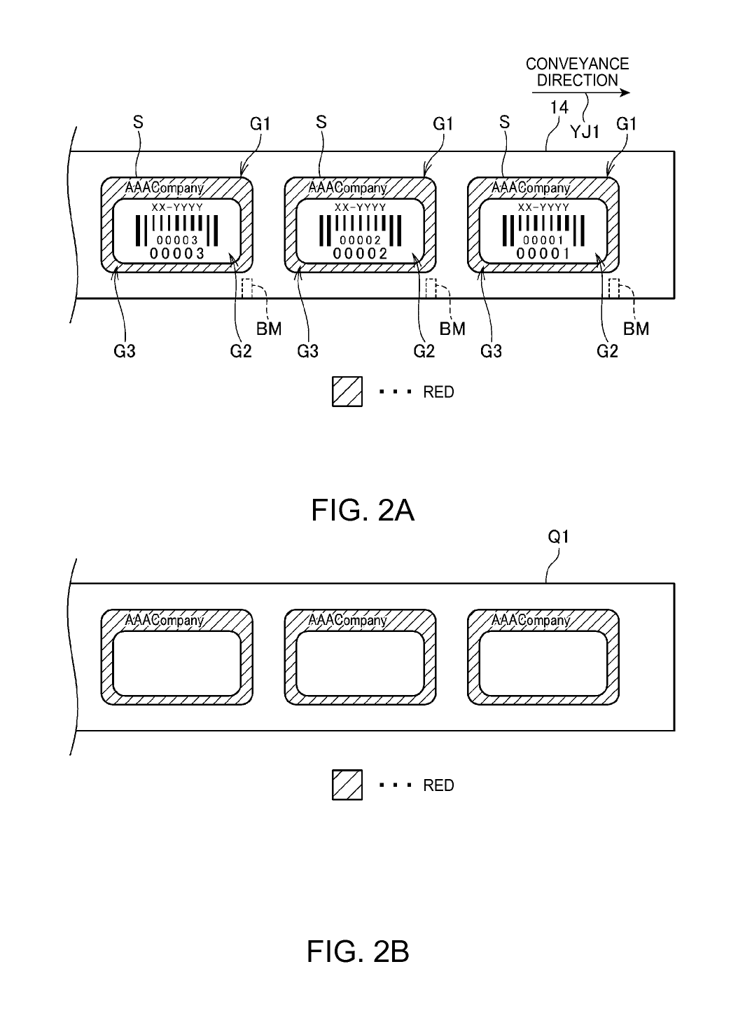

The print medium used as an example in this embodiment of the invention is label paper 14 having labels of a specific size with an adhesive coating on the back affixed to a peelable backer (liner). The label paper 14 and the printing process of the printer 5 are described further below with reference to FIGS. 2A and 2B.

The black mark sensor 42 is an optical sensor disposed at a specific position on the label paper 14 conveyance path and detects black marks BM (FIG. 2A) formed on the label paper 14. The black mark sensor 42 detects the black marks BM while the label paper 14 is conveyed, and outputs a detection value to the printer control unit 27.

The conveyance motor 36 rotationally drives the conveyance roller (not shown in the figure) to convey the label paper 14 as controlled by the printer control unit 27. The conveyance motor 36 can be a stepper motor, for example, and the amount and direction of rotation are controlled by the printer control unit 27. When the conveyance motor 36 turns in the forward direction, the label paper 14 travels forward (in the conveyance direction YJ1 shown in FIG. 2A). When the conveyance motor 36 turns in reverse, the label paper 14 is conveyed in the opposite direction as the conveyance direction YJ1.

The printer control unit 27 has a CPU as the processor unit not shown. The CPU of the printer control unit 27 connects to ROM (not shown in the figure), and the ROM nonvolatilely stores a control program that can be run by the CPU, and data related to the control program. The printer control unit 27 runs the control program stored in ROM, and functions as a print control unit 27a and an image processing unit 27b.

Memory 20 also connects to the printer control unit 27. The memory 20 is a semiconductor storage device generally comprising RAM (random access memory) for temporarily storing data. In this embodiment, the memory 20 temporarily stores the programs run by the CPU, and data related to the programs. The storage area of the memory 20 in this embodiment includes a first layer storage area 21, a second layer storage area 22, and cache memory 23.

Note that the printer control unit 27 may include internal RAM other than memory 20. The printer control unit 27 may also include CPU, ROM, RAM, and other peripheral circuits.

The printer control unit 27 also connects to a printer display unit 39, printer input unit 40, interface 41 (reception unit), and printer storage unit 50.

The printer display unit 39 has LED indicators or an LCD panel for displaying the operating status of the printer 5, for example, and displays information as controlled by the printer control unit 27. The printer input unit 40 has switches, and outputs signals corresponding to operation of the switches to the printer control unit 27.

The interface 41 connects to the interface 49 of the host computer 1, and communicates with the host computer 1 as controlled by the printer control unit 27. The interface 41 is a wired communication interface for communicating through a cable. Alternatively, the interface 41 may be a wireless communication interface for communicating wirelessly through a wireless LAN or using Bluetooth™, for example. The interface 41 also includes any required hardware such as a connector for physical connection, antenna, and interface circuits.

The function blocks of the printer control unit 27 include a print control unit 27a and an image processing unit 27b. The print control unit 27a and image processing unit 27b are embodied by the CPU of the printer control unit 27 running the program for controlling the printer 5, which is described in paragraph 0041.

The print control unit 27a interprets commands the interface 41 receives from the host computer 1, and prints if the command is a command instructing printing. In this process, the print control unit 27a calls the image processing unit 27b. The image processing unit 27b generates print data, which is image data for printing, based on the variable image data 48a the interface 41 receives and/or static image data 50b (print object data) stored in the printer storage unit 50.

The image processing unit 27b renders the variable image data 48a received by the interface 41 in the first layer L1 of the first layer storage area 21 in memory 20. If the command received by the interface 41 is a command specifying a static image data 50b stored by the printer storage unit 50, the image processing unit 27b reads the static image data 50b specified by the command from the printer storage unit 50. In this event, the image processing unit 27b renders the read static image data 50b on the second layer L2 of the second layer storage area 22. The image processing unit 27b generates a composite (merged) image on the second layer L2 by writing the image rendered on first layer L1 to second layer L2. The composite image data generated by the image processing unit 27b is the print data the print control unit 27a uses to print.

The print control unit 27a prints based on the composite image data the image processing unit 27b generates on the second layer L2. More specifically, the print control unit 27a controls the conveyance motor 36 to convey the label paper 14, and drives the inkjet line head 12 to eject ink. The composite image on the second layer L2 is a raster image defining the color to use for printing each pixel in the specific number of dots in the printable area of the printer 5 as described further below.

The print control unit 27a converts the composite image data on the second layer L2, or more specifically color information for each pixel in the print data, to the amount of ink of each color of ink to be ejected by the inkjet line head 12 according to a lookup table (LUT) (not shown in the figure) stored by the printer storage unit 50. Based on the resulting ink volume data, the print control unit 27a determines for each color of ink the location and size of the dots formed by the inkjet line head 12 ejecting ink droplets.

The printer storage unit 50 has a nonvolatile storage medium such as EEPROM, flash memory or other semiconductor memory device, or a hard disk drive, and nonvolatilely stores data, such as large amounts of image data, rewritably. The printer storage unit 50 may be a non-removable device installed in the printer 5, or may be removably connected to the printer 5. For example, the printer storage unit 50 may be a hard disk drive, a memory card, a USB memory stick, or other type of memory device.

The printer storage unit 50 stores a template 50a, static image data 50b, and configuration data 50c.

A template 50a includes data determining where to place images and text when the image processing unit 27b renders variable image data 48a or static image data 50b on the first layer L1.

The static image data 50b is image data for a static image G3 described further below.

In this first embodiment of the invention, the printer storage unit 50 functions as a print object data storage unit.

The configuration data 50c may include data specifying configuration settings related to operation of the printer 5, and more specifically includes data indicating the configuration settings of a process run by the printer control unit 27. For example, when the printer storage unit 50 stores multiple templates 50a, the configuration data 50c includes data specifying a particular template 50a for the image processing unit 27b to select.

FIGS. 2A and 2B are plan views illustrating printing on the label paper 14. FIG. 2A shows a sample of content printed on the label paper 14, and FIG. 2B shows a comparison sample of label paper Q1 that is preprinted as described further below.

FIGS. 2A and 2B show an example of labels that are produced (printed) by the printing system 8 for application to the packaging of an industrial product, for example.

As shown in FIG. 2A, the label paper 14 has a continuous liner (web) of a specific width, and multiple labels S (print areas) affixed with a specific gap therebetween on the printing side 15 of the liner. The label S is a ticket with an adhesive backing, and the manufacturer can easily peel the printed labels S from the liner for affixing to the product or packaging, for example. The size of each label S, and the gap between one label S and the next label S on the label paper 14, are fixed. The inkjet line head 12 ejects ink to the surface of the label S.

The printer 5 conveys the label paper 14 in the conveyance direction (forward conveyance direction) indicated by conveyance direction YJ1 in the figure while printing. The label paper 14 is continuous in the conveyance direction YJ1, and the labels S are arranged in the conveyance direction YJ1. Black marks BM are formed on the back side of the label paper 14. The black marks BM are rectangular marks that are black or other dark color, and in the example shown in FIG. 2A, one black mark BM is formed for each label S. The black marks BM are formed along the side edge of the label paper 14 at the reading position of the black mark sensor 42. The print control unit 27a determines the leading end of a label S based on the position where the black mark sensor 42 detects the black mark BM.

The image the printer 5 prints on a label S is referred to as print image G1. The print image G1 includes a variable image G2 and a static image G3. The variable image G2 is an image that is different on each label S, and in the example shown in FIG. 2 A the variable image G2 includes text and a barcode. The static image G3 is an image that is printed in the same way on multiple labels S, and in the example shown in FIG. 2A includes a red border and logo text.

In the printing system 8, the host computer 1 sends variable image data 48a, which is data for the variable image G2, to the printer 5. The host computer 1 then sends the variable image data 48a for each individual label S. The variable image G2 may be an image that is different for every label S or the same for multiple labels. For example, a common (single) variable image G2 may be used for plural labels S, and the printer 5 may print the same variable image G2 on multiple labels S. In this event, the host computer 1 sends the same variable image data 48a plural times. The host computer 1 may also send variable image data 48a for one image to the printer 5 once, and the printer 5 may duplicate the received variable image data 48a for printing multiple times. This operation of the printer 5 is executed by the host computer 1 sending a command telling the printer 5 to print the same variable image data 48a on plural labels S.

The static image G3 is an image used in a method conventionally called preprinting. Conventionally, the manufacturer producing the labels purchases stock label paper Q1 that has been preprinted with a specific image such as shown in FIG. 2B. The manufacturer producing the labels S purchases label paper Q1 on which the image (variable image G2) that differs on each label S has not been printed, loads the label paper Q1 in the printer 5, and prints the variable image G2 on the label paper Q1 with the printer 5. The manufacturer can thus produce labels on which both the variable image G2 and static image G3 is printed.

By printing both the static image G3 and the variable image G2 with the printer 5, the printing system 8 according to the invention can produce the same labels S without using preprinted label paper Q1, that is, by loading blank (white) label paper in the printer 5.

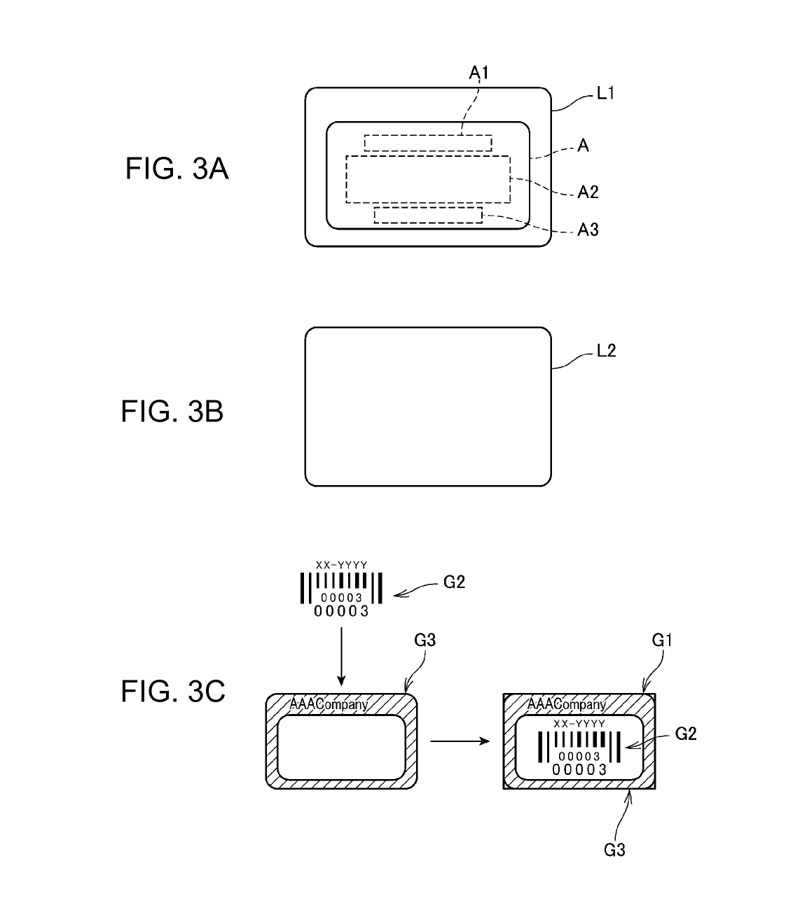

FIGS. 3A-3C illustrate processing layers, FIG. 3A illustrating the configuration of first layer L1, and FIG. 3B illustrating the configuration of second layer L2. FIG. 3C illustrates the process whereby the print control unit 27a merges images.

The first layer L1 shown in FIG. 3A is rendered in the first layer storage area 21 in memory 20, and the second layer L2 shown in FIG. 3B is rendered in the second layer storage area 22.

The first layer storage area 21 is a portion of the physical storage space in memory 20 reserved for storing the first layer L1. The first layer L1 is a virtual space that stores the image rendered from the print object data, and the actual data of the image the printer control unit 27 renders on the first layer L1 is stored in the first layer storage area 21.

The same applies to the second layer L2, and the second layer storage area 22 is a portion of the physical storage space in memory 20 reserved for storing the second layer L2. The second layer L2 is a virtual space for storing the image rendered from the print object data, and the actual data of the image the printer control unit 27 renders on the second layer L2 is stored in the second layer storage area 22.

The first layer storage area 21 and second layer storage area 22 do not need to be contiguous storage areas, and may include non-contiguous storage areas in memory 20, for example.

The capacity of the first layer L1 and the second layer L2 is determined based on the print resolution of the inkjet line head 12 and the size of the printable area of the printer 5. The first layer L1 and the second layer L2 store color information for each of plural pixels (dots). The first layer storage area 21 and second layer storage area 22 store data (color data) related to the color information equal to the pixel count. The first layer storage area 21 and second layer storage area 22 therefore store raster image data corresponding to the number of dots the inkjet line head 12 forms.

The image processing unit 27b generates and writes the raster image data to the first layer L1 based on the variable image data 48a the host computer 1 sent. The variable image data 48a may include text data, barcode data, and image data.

The image processing unit 27b converts text data to an image based on the font data (not shown in the figure) stored in the printer storage unit 50, and writes the image to the first layer L1. The image processing unit 27b likewise converts barcode data to an image based on the barcode font data stored in the printer storage unit 50, and writes the image to the first layer L1. The image processing unit 27b likewise converts vector image data or raster image data to raster image data, and writes the raster image data to the first layer L1.

The process whereby the image processing unit 27b writes text data, barcode data, or image data as raster image data to the first layer L1 is called “rendering.” The image processing unit 27b renders one data object to the first layer L1 as the variable image G2, and can create the variable image G2 by rendering plural images based on plural data objects on the first layer L1.

The capacity of the first layer L1 is at least sufficient to store the data for the number of pixels covering the printable area of the printer 5, for example. Because the entire surface of the label S is the printable area in this embodiment of the invention, the image processing unit 27b can render text and images placed anywhere on the surface of the label S. The locations where the image processing unit 27b places text and images, and the size of any text, are determined by the template 50a.

In the example shown in FIG. 3A, a printable area A where the image processing unit 27b can place text and images is located in the middle of the first layer L1. Located inside this printable area A are an area A1 for placing text, an area A2 for placing a barcode, and an area A3 for placing text corresponding to the barcode. The template 50a includes data specifying the size and location of the printable area A, the size and location of areas A1, A2, and A3, the font and character size of text in areas A1 and A3, and the barcode font used in area A2. The host computer 1 may send the data contained in the template 50a to the printer 5.

When the image processing unit 27b renders the data received through the interface 41 on the first layer L1 based on the template 50a, raster image data for the variable image G2 is created on the first layer L1.

The capacity of the second layer L2 is at least sufficient to store the data for the number of pixels covering the printable area of the printer 5, for example. The image processing unit 27b writes raster image data to the second layer L2 based on the static image data 50b. Rule data may be used to define the location and size of images placed by the image processing unit 27b on the second layer L2. This rule data may be included in the static image data 50b, or included in the template 50a. The template 50a may also contain information specifying static image data 50b.

Note that the capacity of the first layer L1 and the second layer L2 does not need to be sufficient to cover the entire printable area of the printer 5. The capacity of the first layer L1 only needs to be enough for the image processing unit 27b to store the text and images of the variable image G2. The capacity of the second layer L2 only needs to be enough to hold an image larger than the size of the first layer L1. As a result, the storage capacity of the first layer L1 and the storage capacity of the second layer L2 may be different. In this embodiment of the invention, the storage capacity of the second layer storage area 22 may be at least the same as the capacity of the first layer storage area 21, or greater than the capacity of the first layer storage area 21. In other words, the storage capacity of the first layer storage area 21 that stores the first layer L1 may be equal to or less than the storage capacity of the second layer storage area 22 that stores the second layer L2. By using layers with a small storage capacity suited to print object data that can be rendered in a small storage area, memory 20 can be used more efficiently.

As shown in FIG. 3C, the image processing unit 27b writes the variable image G2 rendered on the first layer L1 over the static image G3 rendered on the second layer L2 to produce print image G1. In this process, the print image G1 is written over the static image G3 on the second layer L2. Because there is no need to use an additional storage area to store the print image G1 separately from the first layer L1 and the second layer L2, the storage capacity of the memory 20 can be used efficiently.

This also has the advantage of an image process applied to the variable image G2 not affecting the static image G3 when a particular image process is applied to the variable image G2. More specifically, when rendering vector image data or text data to create the variable image G2 by applying an image process that changes colors or scales the image larger or smaller in the variable image G2, the image processing unit 27b cannot apply these processes to the unrendered data. As a result, the image processing unit 27b must apply the image process to the rendered variable image G2. Because the variable image G2 is rendered on the first layer L1 in this embodiment of the invention, the image processing unit 27b applies the image process to the first layer L1. Because the static image G3 is rendered on the second layer L2 at this time, the static image G3 is not affected by the image process applied to the first layer L1. After image processing the variable image G2 on the first layer L1, the variable image G2 can be merged with the static image G3 on the second layer L2 to acquire the desired print image G1.

One method of merging the variable image G2 and static image G3 renders the static image G3 in a storage area in memory 20, and then overwrites the static image G3 while rendering the variable image G2. With this method, merging the variable image G2 and static image G3 is completed at the same time the rendering the variable image G2 is completed. As a result, if a further image process is applied to the rendered variable image G2, the static image G3 will also be affected by image processing of the variable image G2, and image changes not intended by the operator can occur. By rendering the variable image G2 and static image G3 in different layers and overwriting the image on one layer, this embodiment of the invention eliminates concerns about lowering print quality, and can print by merging plural data objects while maintaining print quality. Furthermore, while using multiple layers requires a larger storage area, the required memory can be reduced and memory 20 can be used efficiently by making the first layer L1 a binary image layer.

The colors of the images rendered on the first layer L1 and the second layer L2 are not specifically limited. The image processing unit 27b may render color images, gray scale images, or monochrome images on either or both the first layer L1 and the second layer L2. More specifically, the first layer storage area 21 and second layer storage area 22 may be configured to store full color raster image data, gray scale image data, or monochrome image data.

In this embodiment of the invention, the first layer L1 is an area for storing monochrome image data. The second layer L2 is an area for storing color raster image data. In other words, the first layer storage area 21 stores monochrome (two valued) raster image data, and the second layer storage area 22 stores color (such as 24-bit full color) raster image data. The two-valued monochrome raster image data stored in the first layer storage area 21 includes a value denoting white (such as 0) or a value denoting black (such as 1) for each pixel.

The process whereby the image processing unit 27b overwrites the first layer L1 image to the second layer L2 image is a process that replaces the color of the corresponding pixel on the second layer L2 with the color of the pixel on the first layer L1. The color of the overwritten pixel on the second layer L2 becomes the color of the pixel on the first layer L1. When the same number of pixels are on the first layer L1 and the second layer L2, the color of the pixel at the same location on the first layer L1 and the second layer L2 is replaced. When the number of pixels on the first layer L1 and the second layer L2 is different, the correlation between the pixels on the first layer L1 and the pixels on the second layer L2 is preset, and the color of the pixel correlated by this setting is replaced.

Because the image processing unit 27b renders a monochrome image on the first layer L1 in this embodiment, the second layer L2 is overwritten with black or white pixels. The image processing unit 27b processes the color of white pixels on the first layer L1 as colorless (having no color). The second layer L2 is therefore not overwritten with pixels that are white on the first layer L1, and the second layer L2 therefore stays the same color as before the images are merged. In other words, the color of the pixel on the second layer L2 corresponding to a black pixel on the first layer L1 is replaced with black, and the color of other pixels stays the same as in the rendered image. In other words, pixels with the value denoting white on the first layer L1 are processed as transparent (colorless) pixels. The print unit 10 of the printer 5 does not use ink to form a white dot, and white areas take the background color of the print medium (that is, the label S). The processing method described above is therefore particularly efficient.

Note that the same effect is achieved when a color image is rendered on the first layer L1 if the image processing unit 27b is configured to not overwrite the second layer L2 with data for pixels that are white ((R, G, B)=(255, 255, 255), for example) or almost white on the first layer L1.

Because the image processing unit 27b generates and writes monochrome raster image data to the first layer L1 based on data related to the variable image G2 received by the interface 41, the variable image G2 becomes a monochrome image. Because this can reduce the required capacity of the first layer L1, the first layer storage area 21 can be embodied with a smaller storage capacity.

Note that in this configuration the first layer L1 is a binary layer for rendering binary (monochrome) images, and the second layer L2 is a multi-valued layered for rendering color (multivalued) images.

The image processing unit 27b can determine the data rendered on the first layer L1 and the data rendered on the second layer L2 based on attributes of the data. More specifically, the image processing unit 27b acquires data for process objects to be rendered on the first layer L1 or second layer L2, assigns the process object data to the first layer L1 if it is monochrome data, and assigns it to the second layer L2 if it is color data. As a result, the image processing unit 27b does not need to determine if the process object data is data sent by the host computer 1 or is data stored in the printer storage unit 50. The data can therefore be assigned to the appropriate layer without being limited by the method of acquiring the data.

Note that monochrome data may be data that does not include a print color specification, text or barcode data that is printed black or gray, or data for a monochrome or gray scale image. Color data is data for text or a barcode for which the specified print color is not black or gray, or color image data.

The method whereby the image processing unit 27b interprets data attributes may be a method that references values related to color contained in the process object data, or a method that references information identifying attributes of the process object data. The information identifying attributes of the process object data may be a file extension or meta data contained in a file. An example of such meta data is a chunk contained in the image header of a PNG file.

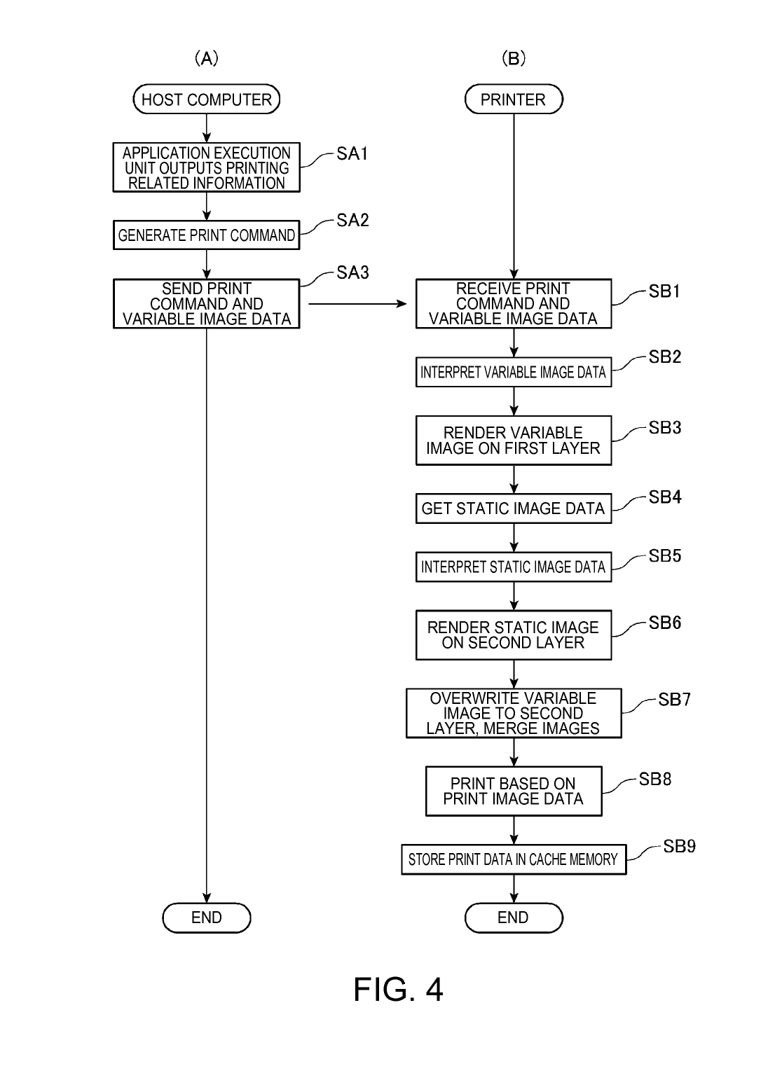

FIG. 4 is a flow chart of the operation of the printing system 8, column (A) of FIG. 4 showing the operation of the host computer 1, and (B) of FIG. 4 showing the operation of the printer 5. FIG. 4 shows particularly the operation of the printer 5 when printing.

The application execution unit 45a of the host computer 1 generates information related to the variable image G2 based on user operations, and outputs to the printer driver execution unit 45b (step SA1). The information the application execution unit 45a outputs may contain the character codes of text strings or the code for a barcode in the variable image G2, or image data for the same. The information the application execution unit 45a outputs may also include information specifying a particular template 50a.

The printer driver execution unit 45b then generates a print command instructing printing (step SA2). The printer driver execution unit 45b stores the variable image data 48a based on the information the application execution unit 45a output in the host storage unit 48, and sends the print command and variable image data 48a through the interface 49 to the printer 5 (step SA3).

The interface 41 of the printer 5 then receives the print command and the variable image data 48a the host computer 1 sent (step SB1). The printer control unit 27 interprets the variable image data 48a (step SB2), and renders the variable image data 48a on the first layer L1 (step SB3). As a result, a variable image G2 based on the variable image data 48a is rendered on the first layer L1.

The printer control unit 27 reads from the printer storage unit 50 and acquires the static image data 50b specified by the print command received through the interface 41 (step SB4). The printer control unit 27 interprets the static image data 50b (step SB5), and renders the static image data 50b on the second layer L2 (step SB6). As a result, a static image G3 based on the static image data 50b is rendered on the second layer L2.

The printer control unit 27 merges the image on the first layer L1 with the image on the second layer L2 and creates the print image G1 by overwriting the image rendered in the first layer L1 to the second layer L2 (step SB7).

The printer control unit 27 converts the data for the merged image on the second layer L2 to ink volume data for the inkjet line head 12 based on a lookup table, and drives the inkjet line head 12 and conveyance motor 36 to print (step SB8). As a result, a print image G1 comprising the static image G3 superimposed with the variable image G2 is printed on a label S.

The printer control unit 27 stores the merged image data in cache memory 23 (step SB9). The image processing unit 27b can read and store the merged image data stored in cache memory 23 in the second layer L2. For example, when the same static image data 50b is rendered multiple times in the second layer L2, the image processing unit 27b writes the merged image data stored in cache memory 23 to the second layer L2. Even greater efficiency can be achieved in this event because the step of the image processing unit 27b converting the static image data 50b to raster image data can be omitted.

The printer control unit 27 can also add a specific file name and an extension denoting a particular file attribute to the merged image data stored in the cache memory 23. The file name and extension may be assigned according to a predefined rule, such as assigning the file name identifying the original static image data 50b and a file extension. This enables identifying data for multiple merged images by the file name and extension.

The printer control unit 27 may also send the merged image data stored in cache memory 23 to the host computer 1. In this event, the host computer 1 receives and stores the merged image data sent by the printer 5 as the merged image data 48b. This merged image data 48b can be used as data related to the print result.

As described above, a printer 5 according to this embodiment has a printer control unit 27 that generates print data by interpreting and rendering data for plural print objects on multiple layers, and merging layers by writing one over the other; and a print unit 10 that prints based on print data generated by the printer control unit 27.

As a result, the printer 5 renders data of a print object as an image on a layer, and produces and prints a merged (composite) image using the layers. A drop in print quality can therefore be prevented and the amount of required memory 20 can be suppressed in a process that generates print data by combining data for plural print objects. The printer 5 can therefore efficiently merge and print print object data.

The printer 5 has memory 20 that stores multiple layers, and the memory 20 has multiple storage areas corresponding to the multiple layers. The storage capacities of the multiple storage areas differ. As a result, data can be efficiently merged and printed using storage areas suited to the amount of data rendered in the layers.

Furthermore, the plural layers include a first layer L1 that is a binary layer, and a second layer L2 that is a multi-valued layer, and the printer control unit 27 renders a binary image on the first layer L1 and renders a multi-valued image on the second layer L2. As a result, the image of the first layer L1 can be stored on the first layer storage area 21 with the small storage capacity, the image of the second layer L2 can be stored on the second layer storage area 22 with the large storage capacity, and memory 20 can be used efficiently to merge data.

Furthermore, because the printer control unit 27 also interprets and allocates the print object data to the first layer L1 and the second layer L2, the print object data can be assigned to the appropriate layer, and memory 20 can be used efficiently to merge data.

Furthermore, when the print object data is binary image data, the printer control unit 27 renders the print object data on the first layer L1, and when the print object data is multi-valued image data, renders the print object data on the second layer L2. As a result, the print object data is rendered on the appropriate layer, and memory 20 can be used efficiently to merge data.

The print unit 10 can also print multiple labels S continuously. The printer control unit 27 renders variable image data 48a, which is print object data acquired for each label S, on the first layer L1, and renders static image data 50b, which is print object data common to plural labels S, on the second layer L2. As a result, a process that prints continuously to multiple labels S can be executed efficiently.

The printer 5 has an interface 41 that receives the variable image data 48a, and can efficiently execute a process of receiving, merging, and printing the print object data.

The printer 5 also has a printer storage unit 50 that stores static image data 50b, and the printer control unit 27 renders the variable image data 48a received through the interface 41 on the first layer L1, and renders static image data 50b stored in the printer storage unit 50 on the second layer L2. As a result, data received by the interface 41 and data stored in the printer storage unit 50 can be efficiently merged and print data.

The print unit 10 also has an inkjet line head 12 that ejects ink, and an inkjet printer 5 with a line head can efficiently merge and print data to be printed.

### Embodiment 2

A second embodiment of the invention is described next.

The configuration of the printing system 8 according to the second embodiment of the invention is substantially the same as the first embodiment shown in FIG. 1 to FIG. 3. Common parts are identified by the same reference numerals, and additional figures and description thereof are omitted.

The operation of the host computer 1 in this second embodiment of the invention is the substantially same as in the first embodiment.

The image processing unit 27b in this second embodiment of the invention can desirably choose either the first layer L1 or the second layer L2 as the layer for rendering the variable image data 48a and static image data 50b. For example, the image processing unit 27b may be configured to render the variable image data 48a on the first layer L1, and render the static image data 50b on the second layer L2. Either the first layer L1 or the second layer L2 is also defined as the active layer in this second embodiment of the invention. The image processing unit 27b renders the variable image data 48a received by the interface 41 on the active layer.

When static image data 50b stored in the printer storage unit 50 is specified by a command received by the interface 41, the image processing unit 27b reads the static image data 50b from the printer storage unit 50.

The image processing unit 27b then renders the read static image data 50b to the first layer L1 or the second layer L2.

The image processing unit 27b generates a composite image on the second layer L2 by overwriting the image rendered on the first layer L1 to the second layer L2. The composite image data generated by the image processing unit 27b is the print data used for printing by the print control unit 27a.

The cache memory 23 is a temporary storage area for storing the images rendered by the image processing unit 27b on the first layer L1 and second layer L2. When the image processing unit 27b renders images on the first layer L1 and second layer L2, the image processing unit 27b can store the rendered images in cache memory 23. All images rendered by the image processing unit 27b can be stored in the cache memory 23, or the images rendered on whichever of first layer L1 and second layer L2 was set for image rendering may be stored in cache memory 23. In this example, image rendered on the second layer L2 are stored in cache memory 23.

In the second embodiment of the invention, the configuration data 50c includes data describing the configuration settings of the active layer. In one example, the configuration data 50c includes data identifying whether the layer set as the active layer is the first layer L1 or the second layer L2. For example, the configuration data 50c may include a value denoting the active layer, such as a 0 indicating the first layer L1 or a 1 indicating the second layer L2. The configuration data 50c may also contain a value indicating there is no active layer. The configuration data 50c may also contain data indicating whether the layer set as the active layer is a two-valued (monochrome) layer or a multivalued layer as described below.

In the second embodiment of the invention, the printer storage unit 50 functions as a configuration data storage unit that stores configuration data 50c, which is data related to the active layer setting.

Of the plural layers (first layer L1 and second layer L2 in this example) that the image processing unit 27b can use for processing, the active layer is the layer that the image processing unit 27b prioritizes for use. The image processing unit 27b renders images on the active layer when variable image data 48a is received through the interface 41, or when static image data 50b is read from the printer storage unit 50. When the host computer 1 sends a command to change the active layer to the printer 5, the printer control unit 27 changes the active layer setting according to the received command.

For example, the printer driver execution unit 45b may generate and send a set layer command and parameter that set the active layer to the printer control unit 27. This parameter is set to 0 to declare the first layer L1 as the active layer, and to 1 to set the second layer L2 as the active layer. A value that means the active layer is not set may also be defined.

As a result, the printing system 8 operates in the following sequence.

1. The image processing unit 27b sets the active layer to the first layer L1 based on the received command.

2. The interface 41 receives the variable image data 48a, and the image processing unit 27b renders an image on the first layer L1.

3. The image processing unit 27b sets (changes) the active layer to the second layer L2 based on the received command.

4. The image processing unit 27b reads the static image data 50b according to a command specifying the static image data 50b and renders an image on the second layer L2.

The host computer 1 sends a command to change the active layer together with a print command and a command and data specifying the static image data 50b. The printer control unit 27 sends commands in the order received by the interface 41. As a result, the printer 5 can be controlled to perform the operations 1 to 4 described above sequentially by controlling the order in which print commands, commands to change the active layer, and commands specifying the static image data 50b are sent.

The image processing unit 27b selects either the first layer L1 or the second layer L2 and renders the variable image data 48a and static image data 50b.

The image processing unit 27b can render the variable image data 48a and can render the static image data 50b to both the first layer L1 and second layer L2. The image processing unit 27b can select which layer to use for rendering data for each data rendering process, but the rendering layers can also be preset.

An example in which the image processing unit 27b renders the variable image data 48a in the first layer L1, and renders the static image data 50b on the second layer L2, is described below.

Based on the variable image data 48a sent by the host computer 1, the image processing unit 27b generates and writes raster image data to the first layer L1. The variable image data 48a includes text data, barcode data, and image data. The image processing unit 27b converts text data to an image based on the font data (not shown in the figure) stored in the printer storage unit 50, and writes the image to the first layer L1. The image processing unit 27b converts barcode data to an image based on the barcode font data stored in the printer storage unit 50, and writes the image to the first layer L1. The image processing unit 27b also converts vector image data or raster image data to raster image data and writes the raster image data to the first layer L1.

The process of the image processing unit 27b thus writing text data, barcode data, or image data to the first layer L1 as raster image data is called rendering. The image processing unit 27b can render a single data object on the first layer L1 as the variable image G2, or combine plural images based on plural data objects on the first layer L1 to create the variable image G2.

The configuration of the first layer L1 and second layer L2 is substantially the same as in the first embodiment. As described in the first embodiment, the image processing unit 27b produces the merged print image G1 by overwriting the variable image G2 rendered on the first layer L1 to the static image G3 on the second layer L2.

If the variable image data 48a received by the interface 41 is color image data and the first layer L1 is a layer for two-valued (monochrome) images, the image processing unit 27b generates and writes a monochrome image based on the variable image data 48a to the first layer L1. In this event, the image processing unit 27b converts color information in the variable image data 48a to two-valued monochrome image information. When the variable image data 48a is gray scale data, the image processing unit 27b likewise creates and writes monochrome image data.

When the variable image data 48a is monochrome data, the image processing unit 27b generates and writes a monochrome image to the first layer L1 based on the variable image data 48a. Monochrome image data is data such as text or barcode data that does not specify the print color or is printed black or gray, or data for a black and white or grayscale image. Color data is data such as text or barcode data that specifies a print color other than black or gray, or color image data.

When the image processing unit 27b renders static image data 50b on the second layer L2, it stores the data for the image rendered on the second layer L2 to the cache memory 23. More specifically, the image processing unit 27b copies the raster image data stored in the second layer storage area 22 to the cache memory 23. Next, the image processing unit 27b then processes the data rendered on the second layer L2, such as overwriting the image on the first layer L1 to the second layer L2.

In this event, the image of the second layer L2 before being overwritten is stored to cache memory 23, and the image processing unit 27b can read and render the data from the cache memory 23 to the second layer L2 or first layer L1. Because the data for the second layer L2 is stored to cache memory 23 in this embodiment, the image processing unit 27b renders the data from the cache memory 23 to the second layer L2.

Because the data stored in cache memory 23 is data that has already been rendered, the load of the process that renders data from the cache memory 23 to the second layer L2 is extremely low. This is because a process for converting text data or vector image data to raster image data, for example, is not necessary. For example, when the same static image data 50b is used multiple times to print multiple labels S, the image processing unit 27b can execute the process of rendering the static image data 50b as raster image data on the second layer L2 once, can thereafter use the data from the cache memory 23, and can greatly reduce the processing load.

The memory 20 in this example is volatile memory, and data in cache memory 23 is therefore held in memory while the printer 5 power remains on. The image processing unit 27b can read and use data from the cache memory 23 multiple times until the data in cache memory 23 is overwritten or deleted.

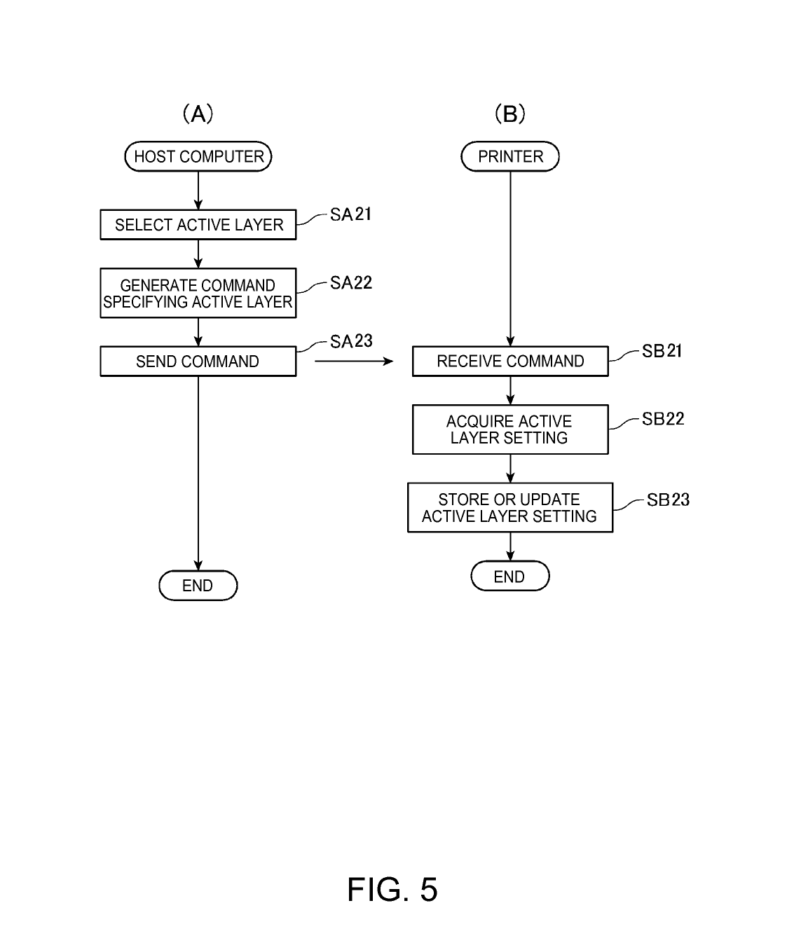

FIG. 5 is a flow chart of the operation of the printing system 8 when setting the active layer. Column (A) of FIG. 5 shows the operation of the host computer 1, and column (B) of FIG. 5 shows the operation of the printer 5.

The printer driver execution unit 45b of the host computer 1 displays a screen for selecting the active layer, and the operator selects the active layer (step SA21). The printer driver execution unit 45b generates a control command specifying the active layer (step SA22), and sends it through the interface 49 to the printer 5 (step SA23).

The printer control unit 27 of the printer 5 receives the control command through the interface 41 (step SB21), and acquires the active layer configuration setting in the received command (step SB22). The printer control unit 27 generates configuration data 50c or updates the configuration data 50c based on the acquired active layer configuration setting (step SB23).

As a result of the process of FIG. 5, either the first layer L1 or the second layer L2 is set as the active layer.

The image processing unit 27b may perform two operations on the active layer.

The first operation, as described above, is for the image processing unit 27b to render the variable image data 48a and static image data 50b on the active layer. More specifically, each time the image processing unit 27b executes the process of rendering print object data, it renders the data on the active layer irrespective of the type of print object data. For example, when the first layer L1 is the active layer, the image processing unit 27b renders the image data on the first layer L1 each time variable image data 48a is received and each time static image data 50b is read. When rendering data on the second layer L2, a process of setting the second layer L2 as the active layer is executed.

In this event, the host computer 1 of the printing system 8 sends the variable image data 48a and a command specifying the static image data 50b to the printer 5, and the printer 5 creates and prints an image based on the variable image data 48a and static image data 50b. The image processing unit 27b renders images on the active layer. When sending variable image data 48a, therefore, the host computer 1 sends a command changing the active layer to the first layer L1 before the variable image data 48a. When sending a command specifying the static image data 50b, the host computer 1 adds and sends a command setting the active layer to the second layer L2 first. As a result, the image processing unit 27b sets the active layer to the first layer L1 and renders an image based on the variable image data 48a, and changes the active layer to the second layer L2 and renders an image based on the static image data 50b, according to the received commands. The image processing unit 27b then overwrites and merges the first layer L1 with the second layer L2, and prints the merged image with the print unit 10.

In the second operation, the image processing unit 27b renders the print object data received by the interface 41 on the active layer. The layer for rendering the print object data read from the printer storage unit 50 may be a layer other than the active layer or may be set separately. Data indicating the layer to use for rendering print object data from the printer storage unit 50 may be included in the configuration data 50c.

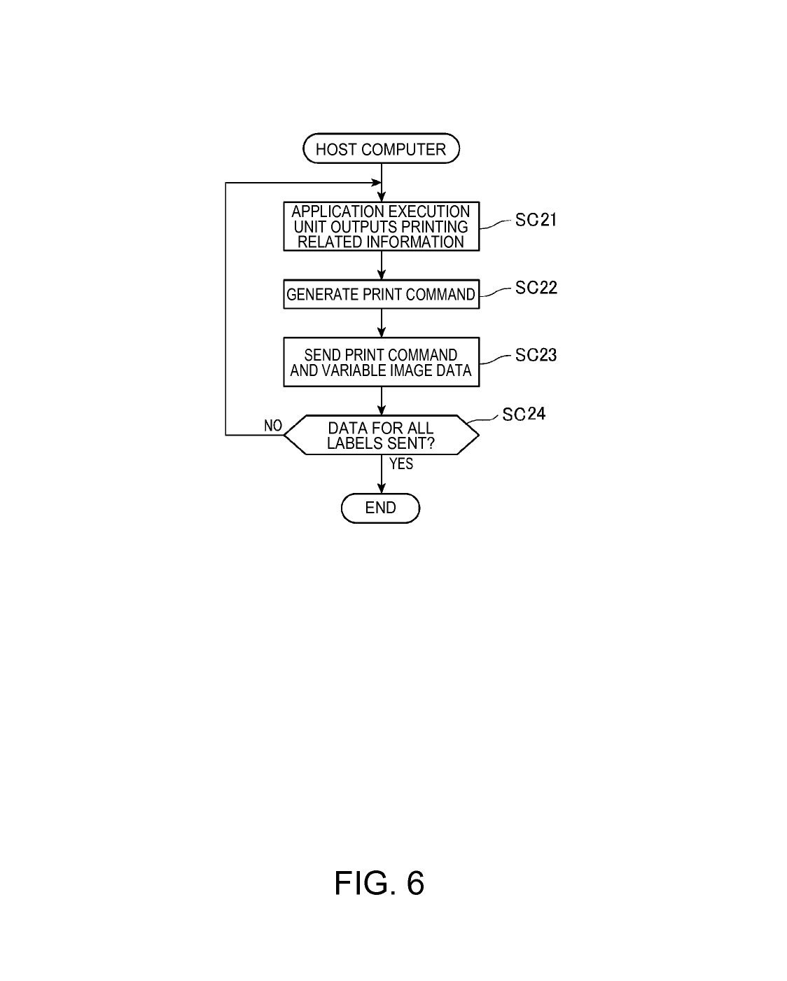

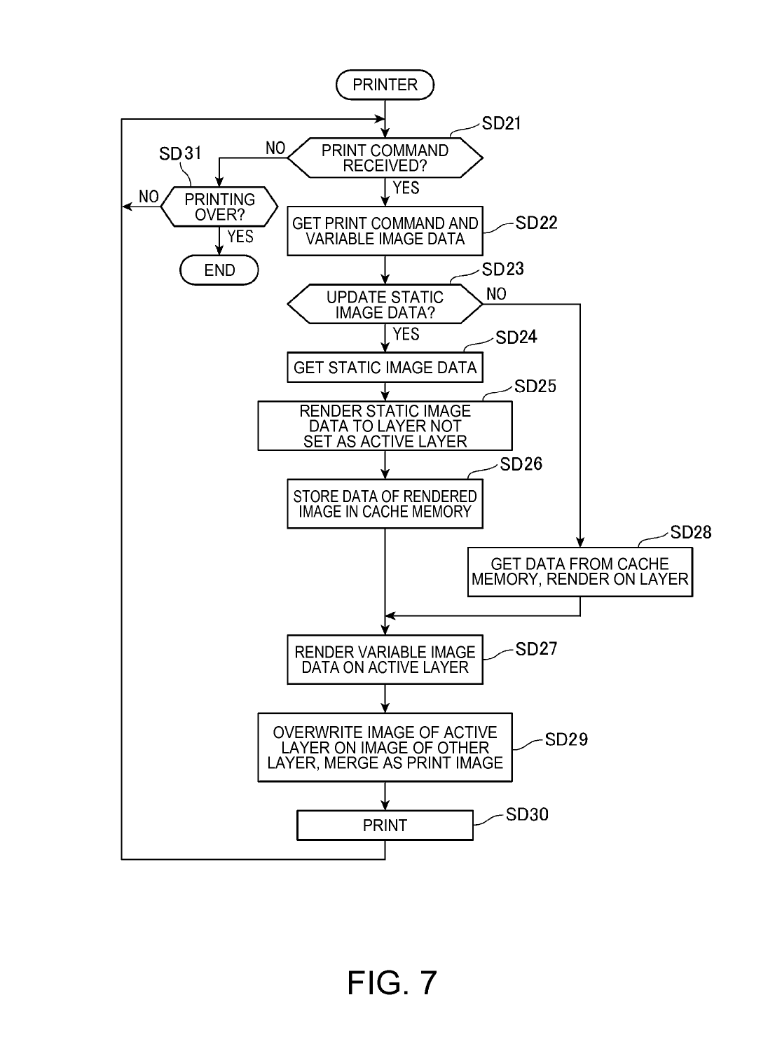

FIG. 6 and FIG. 7 are flow charts showing the operation of the printing system 8 for printing when the active layer is set. FIG. 6 shows the operation of the host computer 1, and FIG. 7 shows the operation of the printer 5.

As shown in FIG. 6, the application execution unit 45a of the host computer 1 generates information related to the variable image G2 according to user operations, and outputs to the printer driver execution unit 45b (step SC21). The information the application execution unit 45a outputs may contain the character codes of text strings or the code for a barcode in the variable image G2, or image data for the text or barcode. Information specifying a particular template 50a may also be included.

The printer driver execution unit 45b generates a print command specifying printing (step SC22). Based on the information the application execution unit 45a output, the printer driver execution unit 45b stores the variable image data 48a in the host storage unit 48, and sends a print command and variable image data 48a through the interface 49 to the printer 5 (step SC23).

The printer driver execution unit 45b determines whether transmission of all of the variable image data 48a is completed (step SC24), and if there is a label S for which the data has not been sent (step SC24 returns No), it returns to step SC1. When transmission of data for all labels S is completed (step SC24 returns Yes), this process ends.

In the operation of steps SC21 to SC24, the application execution unit 45a generates variable image data 48a for one label S at a time, and sends commands and data to the printer 5 for one label S at a time. The application execution unit 45a can also generate data to print on plural labels S, and store variable image data 48a for plural labels S in the host storage unit 48.

The printer driver execution unit 45b may sequentially send a print command and variable image data 48a for one label S to the printer 5. More specifically, the operation of steps SC22 to SC24 executes the same number of times as there are labels S. In this event, the print command that the printer driver execution unit 45b sends includes data specifying the static image data 50b, and the variable image data 48a, which is data for individual labels S.

The printer driver execution unit 45b can also send data for plural labels S in a single batch with a print command to the printer 5. In other words, the printer driver execution unit 45b executes the transmission step once to print plural labels S with the printer 5. In this event, the print command sent by the printer driver execution unit 45b includes data specifying the static image data 50b common to the plural labels S. The variable image data 48a includes the variable image G2 for the plural labels S.

As shown in FIG. 7, the printer 5 receives the print command and variable image data 48a sent by the host computer 1 through the interface 41 (step SD21). The printer control unit 27 then acquires and interprets the print command and variable image data 48a received by the interface (step SD22).

The printer control unit 27 then determines whether or not to update the static image data 50b (step SD23). The printer control unit 27 stores the image data rendered on the second layer L2 in cache memory 23. In step SD23, the printer control unit 27 determines whether the static image data 50b specified by the print command is the previously rendered static image data 50b stored in cache memory 23. If the data stored by the cache memory 23 can be used, the printer control unit 27 determines to not update the static image data 50b (step SD23 returns No). If data different from the data stored in the cache memory 23 is required, the printer control unit 27 determines to update the static image data 50b (step SD23 returns Yes).

To update the static image data 50b, the printer control unit 27 acquires the static image data 50b from the printer storage unit 50 (step SD24). The printer control unit 27 then renders the static image data 50b on the layer not set as the active layer (in this example, the second layer L2) (step SD25). The printer control unit 27 stores the data for the image that was rendered in cache memory 23 (step SD26).

Next, the printer control unit 27 renders the variable image data 48a received by the interface 41 on the active layer (in this example, the first layer L1) (step SD27).

If the static image data 50b is not updated, the printer control unit 27 gets data from cache memory 23, renders it on the layer that is not the active layer (step SD28), and then goes to step SD27.

The printer control unit 27 overwrites the image rendered on the active layer to the layer that is not the active layer, producing the merged print image G1 (step SD29), and then prints the merged print image G1 on a label S (step SD30).

Next, the printer control unit 27 returns to step SD21, and determines if a print command was received (step SD21). If a print command was received (step SD21 returns Yes), control goes to step SD22.

If a print command is not received (step SD21 returns No), whether or not to end printing is determined (step SD31). For example, if the time during which a print command is not received exceeds a specific time, or if printing all labels S based on the received print command and variable image data 48a is completed, printing ends. If printing has not ended (step SD31 returns No), the printer control unit 27 returns to step SD21. If printing ends (step SD31 returns Yes), this process ends.

When the host computer 1 sequentially sends a print command and variable image data 48a for one label S, the printer 5 prints the labels S one by one by the operation in FIG. 6. When the variable image data 48a sent by the host computer 1 contains a variable image G2 for multiple labels S, the printer 5 executes the operation of steps SD22 to SD30 the same number of times as there are labels S to print.

As described above, a printer 5 according to this embodiment has a printer control unit 27 that executes a process that sets one of plural layers as the active layer, and a process that renders print object data on the active layer; and a print unit 10 that prints based on print data generated by the printer control unit 27.

As a result, print object data is rendered as an image on a layer, and the layer can be used to merge and print images. Also, in a process that combines print object data to generate print data, a drop in print quality can be prevented and the required memory 20 capacity can be suppressed. The printer 5 can therefore efficiently merge and print print object data. The layer for rendering the print object data can also be quickly decided, and process efficiency can be improved.

Because the printer 5 has a printer storage unit 50 that stores data related to the active layer setting, the active layer setting can be saved, the frequency of setting the active layer can be reduced, and the task of setting the active layer can be made more efficient.

The printer 5 has memory 20 that stores multiple image layers, wherein the multiple layers stored in the memory 20 include a first layer L1 that is a two-valued layer for rendering monochrome images, and a second layer L2 that is a multi-valued layer for rendering multi-valued images. The memory 20 can therefore be used efficiently by using the layers appropriate to two-valued images and multi-valued images.

When the first layer L1, which is a two-valued layer, is set as the active layer, and the printer control unit 27 renders a variable image data 48a, which is a multi-valued image, the printer control unit 27 renders the variable image data 48a as a two-valued (monochrome) image. In this event, the print unit 10 prints the two-valued image rendered on the first layer L1. Therefore, by setting the first layer L1, which is a two-valued layer, as the active layer, monochrome printing based on color (multi-valued) variable image data 48a is possible.

The printer control unit 27 overwrites the active layer to another layer to merge images and produce the data for the print image G1. The print unit 10 prints based on the data for the print image G1 generated by the printer control unit 27. As a result, the process of merging images does not require a storage area for the image merging process other than the first layer L1 and second layer L2, and memory 20 can be used efficiently to merge data.

The print unit 10 can also print multiple labels S continuously, and the printer control unit 27 may be configured to render print object data acquired for each label S on the two-valued layer, and render the print object data common to plural labels S on a multi-valued layer. In this event, the process of continuously printing plural labels S can be executed efficiently.

The printer 5 also has an interface 41 that receives the print object data, and can efficiently execute the process of receiving, merging, and printing print object data.

The printer 5 also has a printer storage unit 50 that stores static image data 50b, which is print object data. The printer control unit 27 may be configured to render variable image data 48a received by the interface 41 on the two-valued layer, and render static image data 50b stored in the printer storage unit 50 on the multi-valued layer. In this event, the data received by the interface 41 and the data stored in the printer storage unit 50 can be efficiently merged and printed.

The print unit 10 may also have an inkjet line head 12 that ejects ink. A printer 5 with an inkjet line head can efficiently merge and print data to be printed.

### Embodiment 3

A third embodiment of the invention is described next.

The configuration of the printing system 8 according to the third embodiment of the invention is substantially the same as the first embodiment shown in FIG. 1 to FIG. 3, common parts are identified by the same reference numerals, and additional figures and description thereof are omitted.

The operation of the host computer 1 in this third embodiment of the invention is substantially the same as in the first embodiment.

This third embodiment describes an example in which the host computer 1 sends a command to the printer 5 and sets the active layer in the configuration of the second embodiment described above. Operation other than this setting is substantially the same as in the second embodiment.

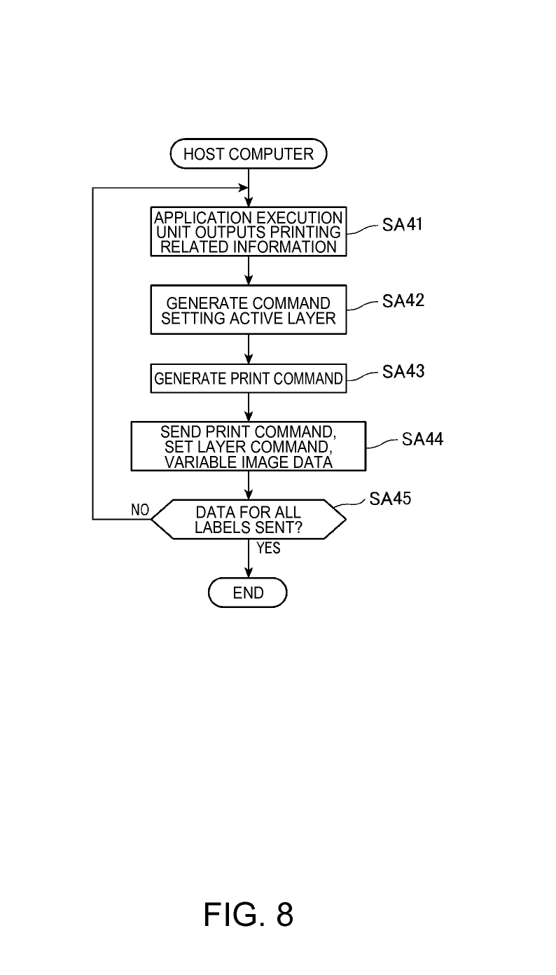

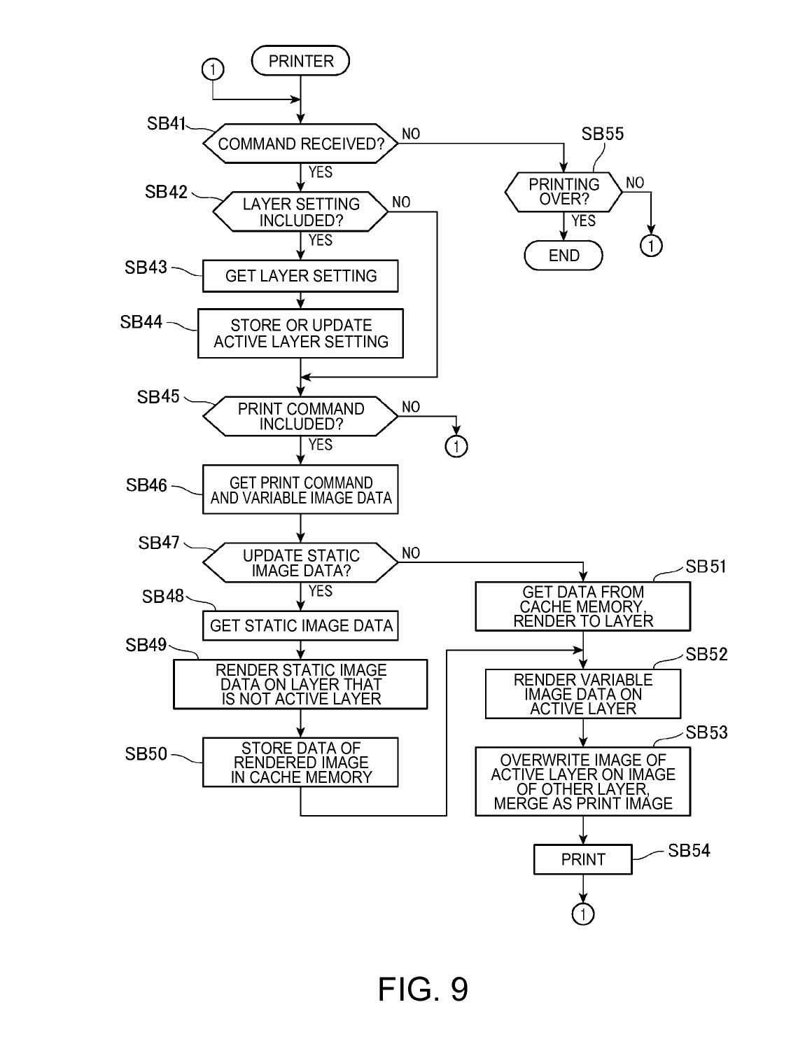

FIG. 8 and FIG. 9 are flow charts showing the operation of the printing system 8 in the third embodiment of the invention, and shows particularly the operation of setting the active layer and printing. FIG. 8 shows the operation of the host computer 1, and FIG. 9 shows the operation of the printer 5.

As shown in FIG. 8, the application execution unit 45a of the host computer 1 generates information related to a variable image G2 based on user operations, and outputs to the printer driver execution unit 45b (step SA41). The information the application execution unit 45a outputs may contain the character codes of text strings or the code for a barcode in the variable image G2, or image data for the same. Information specifying a particular template 50a may also be included.

The printer driver execution unit 45b displays a screen for setting the active layer, and when the user selects the active layer, generates a control command setting the active layer (set layer command) (step SA42).

Based on the information the application execution unit 45a outputs, the printer driver execution unit 45b stores variable image data 48a in the host storage unit 48, and generates a print command instructing printing (step SA43). Next, the printer driver execution unit 45b sends the print command, set layer command, and variable image data 48a through the interface 49 to the printer 5 (step SA44).

The printer driver execution unit 45b prints all labels S if transmission of the variable image data 48a is completed (step SA45), and if there is a label S for which the data has not been sent (step SA45 returns No), it returns to step SA41. When transmission of data for all labels S is completed (step SA45 returns Yes), this process ends.

In the operation of steps SA41 to SA45, the application execution unit 45a generates variable image data 48a for one label S at a time, and sends commands and data to the printer 5 for one label S at a time. The application execution unit 45a can also generate data to print on plural labels S, and store variable image data 48a for plural labels S in the host storage unit 48.

The printer driver execution unit 45b may sequentially send a print command and variable image data 48a for one label S to the printer 5. More specifically, the operation of steps SA42 to SA44 executes the same number of times as there are labels S. In this event, the print command the printer driver execution unit 45b sends includes data specifying the static image data 50b, and the variable image data 48a is data for the individual labels S. In this operation, the step of selecting the active layer in step SA42 executes only once, and only steps SA41 and SA43 to SA45 are repeated for the second and subsequent labels S. Alternatively, the set layer command may be sent every time in step SA44, or the set layer command may be sent only once.

The printer driver execution unit 45b can also send data for plural labels S in a single batch with a print command to the printer 5. In other words, the printer driver execution unit 45b executes the transmission step once to print plural labels S with the printer 5. In this event, the print command sent by the printer driver execution unit 45b includes data specifying the static image data 50b common to the plural labels S. The variable image data 48a includes the variable image G2 for the plural labels S.

As shown in FIG. 9, the printer 5 waits to receive a command sent from the host computer 1 (step SB41). If a command is received through the interface 41 (step SB41 returns Yes), the printer control unit 27 determines whether the received commands include a set layer command (step SB42). If the set layer command is included (step SB42 returns Yes), the printer control unit 27 determines from the set layer command which layer to set as the active layer (step SB43), and based on the active layer setting, generates configuration data 50c or updates the configuration data 50c (step SB44), and then goes to step SB45.

As a result of this process, either the first layer L1 or the second layer L2 can be set as the active layer.

The image processing unit 27b may perform two operations on the active layer.

The first operation, as described above, is for the image processing unit 27b to render the variable image data 48a and static image data 50b on the active layer. More specifically, each time the image processing unit 27b executes the process of rendering print object data, it renders the data on the active layer irrespective of the type of print object data. For example, when the first layer L1 is the active layer, the image processing unit 27b renders the image data on the first layer L1 each time variable image data 48a is received and each time static image data 50b is read. To render data on the second layer L2, a process of setting the second layer L2 as the active layer is executed.

In this event, the host computer 1 of the printing system 8 sends the variable image data 48a and a command specifying the static image data 50b to the printer 5, and the printer 5 creates and prints an image based on the variable image data 48a and static image data 50b. The image processing unit 27b renders images on the active layer. When sending variable image data 48a, therefore, the host computer 1 sends a command changing the active layer to the first layer L1 before the variable image data 48a. When sending a command specifying the static image data 50b, the host computer 1 adds and sends a command setting the active layer to the second layer L2 before the static image data 50b. As a result, the image processing unit 27b sets the active layer to the first layer L1 and renders an image based on the variable image data 48a, and changes the active layer to the second layer L2 and renders an image based on the static image data 50b, according to the received commands. The image processing unit 27b then overwrites and merges the first layer L1 with the second layer L2, and prints the merged image with the print unit 10.

In the second operation, the image processing unit 27b renders the print object data received by the interface 41 on the active layer. The layer for rendering the print object data read from the printer storage unit 50 may be a layer other than the active layer or may be set separately. Data indicating the layer to use for rendering the print object data may be included in the configuration data 50c.

When the received command does not contain a set layer command (step SB42 returns No), the printer control unit 27 goes to step SB45.

In step SB45, the printer control unit 27 determines whether the commands received by the interface 41 include a print command instructing printing (step SB45). If the received commands include a print command instructing printing (step SB45 returns Yes), the printer control unit 27 acquires and interprets the print command and variable image data 48a the interface 41 received (step SB46).

The printer control unit 27 determines whether or not to update the static image data 50b (step SB47). As described above, the printer control unit 27 stores the image data rendered on the second layer L2 in cache memory 23. In step SB43, the printer control unit 27 determines whether the static image data 50b specified by the print command is the previously rendered static image data 50b stored in cache memory 23. If the data stored by the cache memory 23 can be used, the printer control unit 27 determines does update the static image data 50b (step SB47 returns No). If data different from the data stored in the cache memory 23 is required, the printer control unit 27 updates the static image data 50b (step SB47 returns Yes).

To update the static image data 50b, the printer control unit 27 acquires the static image data 50b from the printer storage unit 50 (step SB48). The printer control unit 27 then renders the static image data 50b on the layer not set as the active layer (in this example, the second layer L2) (step SB49). The printer control unit 27 stores the data for the image that was rendered in cache memory 23 (step SB50).

Next, the printer control unit 27 renders the variable image data 48a received by the interface 41 on the active layer (in this example, the first layer L1) (step SB52).

If the static image data 50b is not updated, the printer control unit 27 gets data from cache memory 23, renders it on the layer that is not the active layer (step SB51), and then goes to step SB52.

The printer control unit 27 overwrites the image rendered on the active layer to the layer that is not the active layer, producing the merged print image G1 (step SB53), and then prints the merged print image G1 on a label S (step SB54).

Next, the printer control unit 27 returns to step SB41, and waits to receive a command (step SB41). If a print command was received (step SB41 returns Yes), control goes to step SB42 as described above.

If a print command is not received (step SB41 returns No), the printer control unit 27 determines whether or not to end printing (step SB55). For example, if the time during which a print command is not received exceeds a specific time, or if printing all labels S based on the received print command and variable image data 48a is completed, printing ends. If printing has not ended (step SB55 returns No), the printer control unit 27 returns to step SB41. If printing ends (step SB55 returns Yes), this process ends.

When the host computer 1 sequentially sends a print command and variable image data 48a for one label S, the printer 5 prints the labels S one by one by the operation in FIG. 9. When the variable image data 48a sent by the host computer 1 contains a variable image G2 for multiple labels S, the printer 5 executes the operation of steps SB46 to SB54 the same number of times as there are labels S to print.

In step SB49 and step SB52, the printer control unit 27 references the configuration data 50c and determines whether the active layer is the first layer L1 or the second layer L2. If the commands received in step SB41 do not include a set layer command, the printer control unit 27 controls processing according the setting of the set layer command received previously. As a result, the set layer command may be sent to the host computer 1 only when changing the active layer, and step SA42 in FIG. 8, for example, can be omitted.

An example in which the host computer 1 sends a set layer command together with the print command and variable image data 48a is described in FIG. 8 and FIG. 9, but the host computer 1 may send the set layer command without sending a print command. More specifically, the host computer 1 generates a set layer command in step SA42, and sends the set layer command to the interface 49. In this event, the printer 5 executes the operation of steps SB42 to SB44, and generates or updates the configuration data 50c according to the set layer command. Because a command can thus be used to set the active layer, the active layer can be set when instructing printing, or the active layer can be set at a time other than when printing. The task of the operator related to setting the active layer, and the operation of the host computer 1, are therefore both more efficient.

As described above, a printer 5 according to this embodiment has an interface 41 that receives commands; a printer control unit 27 that executes a process of interpreting the commands received by the interface 41 and selecting a layer based on a received command, and a process of rendering print object data on the selected layer; and a print unit 10 that prints based on the process result of the printer control unit 27.

As a result, the layer for rendering a print object data can be quickly decided, and process efficiency can be improved. In a process that combines print object data to generate print data, a drop in print quality can also be prevented and the required memory capacity can be suppressed. The printer can therefore efficiently merge and print print object data.

The printer control unit 27 overwrites the active layer to another layer to merge images and produce the data for the print image G1. The print unit 10 prints based on the data for the print image G1 generated by the printer control unit 27. As a result, the process of merging images does not require a storage area for the image merging process other than the first layer L1 and second layer L2, and memory 20 can be used efficiently to merge data.

The printer 5 has memory 20 storing multiple image layers, the memory 20 has the first layer storage area 21 and second layer storage area 22 as storage areas corresponding to the multiple layers, and the storage capacities of these plural storage areas are different. Data can therefore be efficiently merged and printed using storage areas appropriate to the amount of data rendered on each layer.

The multiple layers stored in the memory 20 include a two-valued layer for rendering monochrome images, and a multi-valued layer for rendering multi-valued images, and the memory can be used efficiently by using the layers appropriate to two-valued images and multi-valued images.

The printer 5 may receive print object data through the interface 41, and the printer control unit 27 configured to render two-valued print object data received by the interface 41 on the two-valued layer. In this event, print object data can be received by the interface 41 that receives commands, render the print object data on the appropriate layer, and memory 20 can be used efficiently to merge data.

For example, two-valued (monochrome) images can be rendered on the first layer L1 corresponding to the low storage capacity first layer storage area 21, and color images can be rendered on the second layer L2 corresponding to the high storage capacity second layer storage area 22. More specifically, the memory 20 may be configured to store plural image layers including a first layer L1, which is a two-valued layer, and a second layer L2, which is a multi-valued layer. In this event, the printer control unit 27 renders two-valued images on the first layer L1 and renders multi-valued images on the second layer L2. As a result, memory 20 can be used efficiently to merge data.

Each time print object data is received, the interface 41 of the printer 5 also receives a command related to selecting a layer. As a result, the layer used to render the print object data for each print job can be selected according to the command.

The printer 5 also has a printer storage unit 50 that stores data related to the layer selected by the printer control unit 27 based on the command as configuration data 50c. As a result, the layer setting can be stored, the layer can be set less frequently, and the task of setting the layer can be made more efficient.

The print unit 10 of the printer 5 can print continuously to multiple labels S, and the printer control unit 27 may render variable image data 48a, which is two-valued print object data received by the interface 41 for each label S, and multi-valued static image data 50b common to plural labels S. When printing continuously to plural labels S, print object data that is different on each label S, and print object data that is common to the plural labels S, can be rendered separately and efficiently. Because the print object data that is different on each label S is two-valued, the processor load can be reduced.

The print unit 10 may be configured with an inkjet line head 12 that ejects ink. A printer 5 having an inkjet line head 12 can efficiently merge and print data to print.

The embodiments described above are examples of the present invention, and can be changed and modified in many ways without departing from the scope of the accompanying claims.

For example, in the first to third embodiments described above, the print image G1 printed on a label S includes a variable image G2 and a static image G3, the image processing unit 27b merges the variable image G2 and static image G3, and the print unit 10 prints the resulting merged image. The invention is not so limited, however, as the variable image G2 alone can be printed on a label S, and the raster image rendered on the second layer L2 may be white space.

Either or both the first layer L1 and the second layer L2 may also contain data related to pixel transparency.

Furthermore, the function blocks shown in FIG. 1 can be achieved as desired by the cooperation of hardware and software. The functions of the host computer 1 and the printer 5 may also be handled by discrete devices externally connected thereto. The operations described above can also be achieved by the host computer 1 and printer 5 running programs stored on an externally connected storage medium.

The printer 5 is also not limited to an inkjet printer, and the invention can be applied to dot impact printers, laser printers, thermal printers, and other types of printers, and to multifunction devices incorporating such a print unit.

As described above, the present invention can be used in function extension methods for extending the functionality of an application using print data that is output from an existing application, and is particularly useful to function extension methods that can easily add a variety of functions without changing the program of an existing application and without using an existing printer driver.

The invention being thus described, it will be apparent that it may be varied in many ways. Such variations are not to be regarded as a departure from the spirit and scope of the invention, and all such modifications as would be apparent to one skilled in the art are intended to be included within the scope of the following claims.

What is claimed is:

1. A printing device comprising:
an image processing unit that interprets and renders plural print object data on plural layers, and produces print data by merging layers by overlaying one layer on another layer; and
a print unit that prints based on the print data generated by the image processing unit.

2. The printing device described in claim 1, further comprising:
memory that stores plural layers,
the memory having a plurality of storage areas corresponding to the plural layers, and the plural storage areas having different storage capacities.

3. The printing device described in claim 1, wherein:
the layers include a two-valued layer and a multi-valued layer;
the image processing unit rendering a two-valued image on the two-valued layer and a multi-valued image on the multi-valued layer.

4. The printing device described in claim 3, wherein:
the image processing unit interprets and renders the print object data appropriately on the two-valued layer and multi-valued layer.

5. The printing device described in claim 4, wherein:
the image processing unit renders the print object data on the two-valued layer when the print object data is two-valued image data, and renders the print object data on the multi-valued layer when the print object data is multi-valued image data.

6. The printing device described in claim 3, wherein:
the print unit prints continuously to plural print areas; and
the image processing unit renders the print object data acquired for each print area on the two-valued image, and renders print object data common to plural print areas on the multi-valued layer.

7. The printing device described in claim 3, further comprising:
a reception unit that receives the print object data.

8. The printing device described in claim 7, further comprising:
a print object data storage unit that stores the print object data;
the image processing unit rendering the print object data received by the reception unit on the two-valued layer, and rendering the print object data stored in the print object data storage unit on the multi-valued layer.

9. The printing device described in claim 4, wherein:
the image processing unit executes a process setting one of the plural layers as the active layer, and a process rendering the print object data on the active layer.

10. The printing device described in claim 9, further comprising:
a configuration data storage unit that stores data related to the active layer setting.

11. The printing device described in claim 10, wherein:
when the two-valued layer is the active layer, the image processing unit renders a two-valued image on the two-valued layer based on the print object data of a color image; and
the print unit prints the two-valued image rendered on the two-valued layer.

12. The printing device described in claim 9, wherein:
the image processing unit merges the active layer with another layer and produces print data; and
the print data prints based on the print data generated by the image processing unit.

13. The printing device described in claim 9, wherein:
the print unit prints continuously to plural print areas; and
the image processing unit renders the print object data acquired for each print area on the active layer.

14. The printing device described in claim 9, further comprising:
a reception unit that receives the print object data;
the image processing unit rendering the print object data received by the reception unit on the active layer.

15. The printing device described in claim 4, further comprising:
a reception unit that receives a command;
the image processing unit executing a process of interpreting the command received by the reception unit and selecting a layer based on the command, and a process of rendering the print object data on the selected layer.

16. The printing device described in claim 15, wherein:
the print unit receives the print object data; and
the image processing unit renders the two-valued print object data received by the reception unit on the two-valued layer.

17. The printing device described in claim 15, wherein:
the reception unit receives the command related to selection of the layer each time the print object data is received.

18. The printing device described in claim 15, further comprising:
a configuration data storage unit that stores data related to the layer the image processing unit selects based on the command.

19. The printing device described in claim 15, wherein:
the print unit prints continuously to plural print areas; and
the image processing unit renders the two-valued print object data the reception unit receives for each print area, and multi-valued print object data common to plural print areas.

20. The printing device described in claim 1, wherein:
the print unit has a line head that ejects ink.

21. A control method of a printing device, comprising steps of:
interpreting and rendering plural print object data on plural layers;
producing print data by merging layers by overlaying one layer on another layer; and
printing based on the generated print data.

22. The control method of a printing device described in claim 21, further comprising:
setting one of the plural layers as the active layer;
rendering the print object data on the active layer; and
printing based on the result of rendering data.

23. The control method of a printing device described in claim 21, further comprising:
interpreting a command and selecting a layer based on the command; and
rendering the print object data on the selected layer.

24. The control method of a printing device described in claim 21, further comprising:
when the layers include a two-valued layer and a multi-valued layer,
interpreting and allocating the print object data to the two-valued layer and the multi-valued layer, rendering two-valued images on the two-valued layer, and rendering multi-valued images on the multi-valued layer.
